(19) United States
(12) Patent Application Publication
(10) Pub. No.: US 2025/0253625 A1
(43) Pub. Date: Aug. 7, 2025

(54) HIGH-VOLTAGE AND HIGH-CURRENT LAMINATED BUS LINE AND PREPARATION METHOD THEREOF

(71) Applicant: HEFEI INSTITUTE OF PHYSICAL SCIENCE, CHINESE ACADEMY OF SCIENCES, Hefei (CN)

(72) Inventors: Li JIANG, Hefei (CN); Hua CAO, Hefei (CN); Qiangjian CHEN, Hefei (CN)

(73) Assignee: HEFEI INSTITUTE OF PHYSICAL SCIENCE, CHINESE ACADEMY OF SCIENCES, Hefei (CN)

(21) Appl. No.: 18/895,454

(22) Filed: Sep. 25, 2024

Related U.S. Application Data
(63) Continuation of application No. PCT/CN2024/080285, filed on Mar. 6, 2024.

(30) Foreign Application Priority Data
Feb. 2, 2024 (CN) 202410154717.5

(51) Int. Cl. H02B 1/20; H02B 11/04; H02G 5/00

(52) U.S. Cl. CPC H02B 1/20; H02B 11/04; H02G 5/005

(57) ABSTRACT

A high-voltage and high-current laminated bus line and a preparation method thereof are provided. The preparation method includes the following steps: winding a positive bus line and a negative bus line by using a glass cloth tape to form an insulated positive bus line and an insulated negative bus line, twining the insulated positive bus line, a metal isolation plate and the insulated negative bus line by using the glass cloth tape to form a laminated bus line sample, and heating and curing the laminated bus line sample to obtain the high-voltage and high-current laminated bus line. The laminated bus line has low self-generated impedance and small installation space requirement, and is suitable for high-power electrical equipment with a current exceeding 30 kA and a total voltage exceeding 20 kV.

### CROSS REFERENCE TO THE RELATED APPLICATIONS

This application is a continuation application of International Application No. PCT/CN2024/080285, filed on Mar. 6, 2024, which is based upon and claims priority to Chinese Patent Application No. 202410154717.5, filed on Feb. 2, 2024, the entire contents of which are incorporated herein by reference.

### TECHNICAL FIELD

The present invention relates to the technical field of electric power equipment, and in particular, to a high-voltage and high-current laminated bus line and a preparation method thereof.

### BACKGROUND

A bus line refers to a product made of high-conductivity copper or aluminum materials for transmitting electrical energy and for collecting and distributing electricity. The bus line is also a main conductor for transmitting electric energy to a power plant or a transformer station, and the electric energy output by a generator, a transformer or a rectifier is transmitted to various users or other substations through the bus line. At present, a large-current and high-power bus line used for nuclear power in China mainly adopts a split bus line, and cannot meet the increasing demands due to large occupied area and large stray resistance.

The conventional laminated bus line has a voltage of less than several thousand volts and a current of less than several thousand amperes. This laminated bus line is mostly used in low-voltage and low-current occasions such as frequency converters and is a special component inside the equipment. A high-current and high-voltage bus line requires the use of closed or insulation sleeves. However, this bus line has a large self-generated impedance, requires a large installation space, and has a low current intensity (several thousand amperes), which cannot meet the increasing demands.

At present, the direct current transmission and distribution requirements for a single set of power supply system must meet a maximum current of 30 kA and a maximum voltage of 10 kV. Therefore, how to provide a set of novel high-voltage and high-current laminated bus line has become an issue that urgently needs to be addressed by those skilled in the art.

### SUMMARY

In view of this, the present invention provides a high-voltage and high-current laminated bus line and a preparation method thereof, which aims to solve the technical problem that the conventional laminated bus line cannot be directly applied to high-power electrical equipment.

To achieve the above objective, the present invention adopts the following technical solutions.

The present invention provides a high-voltage and high-current laminated bus line, which comprises an insulated positive bus line, a metal isolation plate and an insulated negative bus line; and
the metal isolation plate is positioned between the insulated positive bus line and the insulated negative bus line, the insulated positive bus line comprises an insulating layer and a positive bus line, the insulated negative bus line comprises an insulating layer and a negative bus line, and a thickness of the insulating layer is 1-10 mm independently.

Further, cross-sectional areas of the positive bus line and the negative bus line are 10000-15000 mm² independently.

Further, centers of the positive bus line and the negative bus line each comprise a water through hole, and an area of the water through hole is 300-400 mm² independently.

Further, the positive bus line, the negative bus line and the metal isolation plate are independently made of any one of aluminum, copper, aluminum alloy, and copper alloy.

Further, the insulating layer is a glass cloth tape.

The present invention provides a preparation method of the high-voltage and high-current laminated bus line, which comprises the following steps:
winding a positive bus line and a negative bus line by using a glass cloth tape to form an insulated positive bus line and an insulated negative bus line, twining the insulated positive bus line, a metal isolation plate and the insulated negative bus line by using the glass cloth tape to form a laminated bus line sample, and heating and curing the laminated bus line sample to obtain the high-voltage and high-current laminated bus line; wherein
a thickness of the twining is 1-10 mm; and
the heating and curing treatment is performed at 160-180° C. for 20-30 h.

Further, the positive bus line and the negative bus line are coated with an epoxy adhesive and then are wound with the glass cloth tape; and the glass cloth tape used is saturated with the epoxy adhesive.

Further, the epoxy adhesive comprises epoxy resin and/or curing agent anhydride.

Further, after the heating and curing treatment is completed, the laminated bus line sample is subjected to a temperature reduction treatment and a surface passivation treatment in sequence.

Further, the temperature reduction treatment is performed at a rate of ≤2° C./min.

It can be known from the technical solutions that, compared with the conventional technology, the present invention has the following beneficial effects:
1. The preparation method of the present invention can be used for one-time curing and forming, and reduces the risks of processing and bonding defects of multiple curing processing interfaces;
2. The high-voltage and high-current laminated bus line prepared by the present invention has a large conductor current carrying capacity; and
3. The high-voltage and high-current laminated bus line prepared by the present invention can save the installation space.

### BRIEF DESCRIPTION OF THE DRAWINGS

FIG. 1 is a cross section of a high-voltage and high-current laminated bus line prepared by the present invention;

FIG. 2 is an elbow of a high-voltage and high-current laminated bus line prepared by the present invention; and

FIG. 3 is an end of a high-voltage and high-current laminated bus line prepared by the present invention.

### DETAILED DESCRIPTION OF THE EMBODIMENTS

The present invention provides a high-voltage and high-current laminated bus line, which comprises an insulated positive bus line, a metal isolation plate and an insulated negative bus line; and
the metal isolation plate is positioned between the insulated positive bus line and the insulated negative bus line, the insulated positive bus line comprises an insulating layer and a positive bus line, the insulated negative bus line comprises an insulating layer and a negative bus line, and a thickness of the insulating layer is 1-10 mm independently, preferably 2-8 mm, and further preferably 4-6 mm.

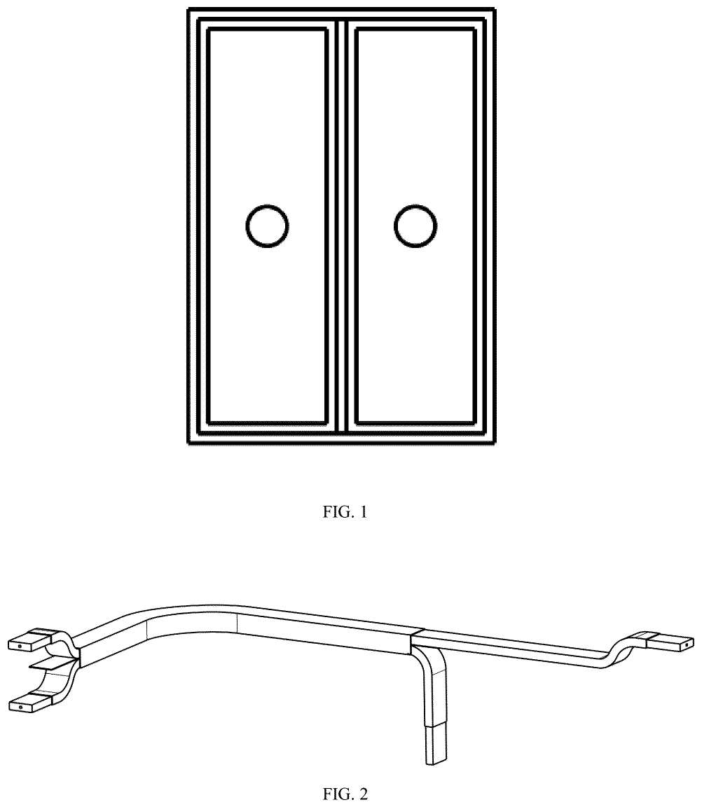

In the present invention, FIG. 1 shows a cross section of the high-voltage and high-current laminated bus line, the high-voltage and high-current laminated bus line is symmetrical by a metal isolation plate, so that an electric field between a positive bus line and a negative bus line is uniform; and the metal isolation plate can achieve the electrical isolation between the positive bus line and the negative bus line.

In the present invention, cross-sectional areas of the positive bus line and the negative bus line are 10000-15000 mm² independently, preferably 11000-14000 mm², and more preferably 12000-13000 mm².

In the present invention, centers of the positive bus line and the negative bus line each comprise a water through hole, and an area of the water through hole is 300-400 mm² independently, preferably 320-380 mm², and more preferably 340-360 mm²; and a shape of water through hole is preferably circular, and a diameter of circular hole is preferably 15-25 mm, and more preferably 18-22 mm.

In the present invention, the positive bus line and the negative bus line are prepared by a hot mandrel bending process, which is described in the “Basic Mold Design, 2nd edition” by Chen Jianhe and Wu Yunfei. The hot mandrel bending process can bend the positive bus line and the negative bus line in the width direction and the length direction (the bending radius is greater than or equal to 2.5D, preferably greater than or equal to 3.5D, and more preferably greater than or equal to 4.0D), as shown in FIG. 2, the rapid connection between the positive bus line and the negative bus line and between the positive bus line, the negative bus line and the equipment is facilitated, and meanwhile, the phenomenon that a water channel is easily damaged or cracks in the bending process is prevented.

In the present invention, the positive bus line, the negative bus line and the metal isolation plate are independently made of any one of aluminum, copper, aluminum alloy and copper alloy, preferably copper or aluminum, and more preferably aluminum.

In the present invention, the insulating layer is a glass cloth tape.

The present invention provides a preparation method of the high-voltage and high-current laminated bus line, which comprises the following steps:
winding a positive bus line and a negative bus line by using a glass cloth tape to form an insulated positive bus line and an insulated negative bus line, twining the insulated positive bus line, a metal isolation plate and the insulated negative bus line by using the glass cloth tape to form a laminated bus line sample, and heating and curing the laminated bus line sample to obtain the high-voltage and high-current laminated bus line; wherein
a thickness of the twining is 1-10 mm, preferably 2-8 mm, and more preferably 4-6 mm;
a temperature of the heating and curing treatment is 160-180° C., preferably 165-175° C., and more preferably 170° C.; and a period of the heating and curing treatment is 20-30 h, preferably 22-28 h, and more preferably 24-26 h.

In the present invention, the positive bus line and the negative bus line are coated with an epoxy adhesive and then are wound with the glass cloth tape; and the glass cloth tape used is saturated with the epoxy adhesive. After the twining, the positive bus line and the negative bus line have rounded corners, which form grooves at the joints, and the grooves can be filled with the epoxy adhesive to be smooth.

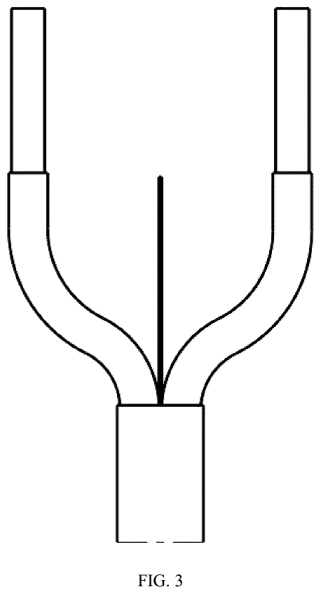

In the present invention, the glass cloth tape winds the positive bus line and the negative bus line at 45° and half-pressed. When the glass cloth tape winds to the end of each layer, as shown in FIG. 3, a small head can be formed, the small head part is pre-wound by the glass cloth tape with the width reduced by half at the end for compensation, and the surface of each layer is flat after winding is achieved. The end is also subjected to nickel plating treatment, and the nickel plating treatment adopts the solution described in the “Electroplating Nickel Process Specifications” to reduce the contact resistance of the positive (negative) bus line and prevent the surface oxidation of the positive (negative) bus line.

In the present invention, the epoxy adhesive comprises an epoxy resin and/or curing agent anhydride, and the curing agent anhydride is preferably one or more of phthalic anhydride, tetrahydrophthalic anhydride and hexahydrophthalic anhydride, and more preferably phthalic anhydride.

In the present invention, the laminated bus line sample is pressed and compacted by a mold before the heat and curing treatment.

In the present invention, after the heating and curing treatment is completed, the laminated bus line sample is subjected to a temperature reduction treatment and a surface passivation treatment in sequence.

In the present invention, the temperature reduction treatment is performed at a rate of ≤2° C./min, preferably ≤1.8° C./min, and more≤1.5° C./min; and
the surface passivation treatment comprises the following specific steps: firstly, performing surface polishing; secondly, performing surface cleaning; thirdly, performing protection treatment on two ends of the conductor; fourthly, performing protection treatment on the insulating surface; the purpose of surface passivation treatment is to ensure the smooth and beautiful surface of the high-voltage and high-current laminated bus line.

The technical solutions provided by the present invention will be described in detail below with reference to examples, which, however, should not be construed as limiting the scope of the present invention.

### Example 1

A positive aluminum bus line and a negative aluminum bus line with cross sections of 200×60 mm were prepared by a hot mandrel bending process, and circular water through holes with a diameter of 20 mm were formed in the centers of the cross sections of the positive bus line and the negative bus line. The burrs on the surfaces of the positive bus line and the negative bus line were removed. After the surfaces were cleaned, a layer of the epoxy adhesive (phthalic anhydride) was rolled on the positive bus line and negative bus line, and then the glass cloth tape soaked with the epoxy adhesive (phthalic anhydride) was used to wind the positive bus line and negative bus line to form an insulated positive bus line and an insulated negative bus line. Since the positive bus line and the negative bus line were provided with rounded corners, which formed grooves at the joints, the grooves were filled with the epoxy adhesive (phthalic anhydride) to be smooth. The insulating layers of the insulated positive bus line and negative bus line were 5 mm, and then the glass cloth tape soaked with the epoxy adhesive (phthalic anhydride) was used to twine the insulated positive bus line, an aluminum isolation plate and the insulated negative bus line to form a laminated bus line sample. When the thickness of the twining reached 5 mm, the laminated bus line sample was placed in a mold, a pressure template was pressed on sides of the sample, a clamp was clamped on the pressure plate and slowly rotated to gradually pressurize and compact the sample, then the compacted laminated bus line sample was placed in a curing furnace, and the laminated bus line sample was slowly rotated for heating and curing. After curing at 180° C. for 22 h, the sample was cooled to room temperature, and then the surface of the laminated bus line sample was subjected to passivation treatment to ensure the smoothness and beauty of the product surface. Finally, the end of the high-voltage and high-current laminated bus line was subjected to nickel plating treatment to obtain the high-voltage and high-current laminated bus line.

### Example 2

A positive aluminum bus line and a negative aluminum bus line with cross sections of 200×50 mm were prepared by a hot mandrel bending process, and circular water through holes with a diameter of 15 mm were formed in the centers of the cross sections of the positive bus line and the negative bus line. The burrs on the surfaces of the positive bus line and the negative bus line were removed. After cleaning the surfaces, a layer of the epoxy resin adhesive was rolled on the positive bus line and negative bus line, and then the glass cloth tape soaked with the epoxy resin adhesive was used to wind the positive bus line and negative bus line to form an insulated positive bus line and an insulated negative bus line. Since the positive bus line and negative bus line had rounded corners, which formed grooves at the joints, the grooves were filled with the epoxy resin adhesive to be smooth. The insulating layers of the insulated positive bus line and negative bus line were 3 mm, and then the glass cloth tape soaked with the epoxy resin adhesive was used to twine the insulated positive bus line, an aluminum isolation plate and the insulated negative bus line to form a laminated bus line sample. When the thickness of the twining reached 8 mm, the laminated bus line sample was placed in a mold, the pressure template was pressed on sides of the sample, the clamp was clamped on the pressure plate and slowly rotated to gradually pressurize and compact, then the compacted laminated bus line sample was placed in a curing furnace, and the laminated bus line sample was slowly rotated for heating and curing. After curing at 170° C. for 25 h, the sample was cooled to room temperature, and then the surface of the laminated bus line sample was subjected to passivation treatment to ensure the smoothness and beauty of the product surface. Finally, the end of the high-voltage and high-current laminated bus line was subjected to nickel plating treatment to obtain the high-voltage and high-current laminated bus line.

### Example 3

A positive aluminum bus line and a negative aluminum bus line with cross sections of 200×70 mm were prepared by a hot mandrel bending process, and square water through holes with a side of 18 mm were formed in the centers of the cross sections of the positive bus line and the negative bus line. The burrs on the surfaces of the positive bus line and the negative bus line were removed. After cleaning the surfaces, a layer of the epoxy resin adhesive was rolled on the positive bus line and negative bus line, and then the glass cloth tape soaked with the epoxy resin adhesive was used to wind the positive bus line and negative bus line to form an insulated positive bus line and an insulated negative bus line. Since the positive bus line and negative bus line had rounded corners, which formed grooves at the joints, the grooves were filled with the epoxy resin adhesive to be smooth. The insulating layers of the insulated positive bus line and negative bus line were 8 mm, and then the glass cloth tape soaked with the epoxy resin adhesive was used to twine the insulated positive bus line, an aluminum isolation plate and the insulated negative bus line to form a laminated bus line sample. When the thickness of the twining reached 6 mm, the laminated bus line sample was placed in a mold, the pressure template was pressed on sides of the sample, the clamp was clamped on the pressure plate and slowly rotated to gradually pressurize and compact, then the compacted laminated bus line sample was placed in a curing furnace, and the laminated bus line sample was slowly rotated for heating and curing. After curing at 160° C. for 28 h, the sample was cooled to room temperature, and then the surface of the laminated bus line sample was subjected to passivation treatment to ensure the smoothness and beauty of the product surface. Finally, the end of the high-voltage and high-current laminated bus line was subjected to nickel plating treatment to obtain the high-voltage and high-current laminated bus line.

Various properties of the high-voltage and high-current laminated bus line prepared in Examples 1 to 3 were tested, and the test items and the test results are shown in Table 1.

TABLE 1
Property test results

| Test items | Example 1 | | Example 2 | | Example 3 | |
|---|---|---|---|---|---|---|
| Hydraulic pressure | Without leakage | | Without leakage | | Without leakage | |
| (10 kg/6 h) | | | | | | |
| Withstand voltage | Pass | | Pass | | Pass | |
| (20 kV/min) | | | | | | |
| Flammability UL-94 | Grade V0 | | Grade V0 | | Grade V0 | |
| Steady state current | 32 | kA | 30 | kA | 35 | kA |
| Pulse current | 230 | kA | 250 | kA | 270 | kA |
| Steady state temperature rise | ≤40° | C. | ≤40° | C. | ≤40° | C. |
| Resistance | ≤4.65 | μΩ/m | ≤4.69 | μΩ/m | ≤4.70 | μΩ/m |

| | | | |
|---|---|---|---|
| Insulating material ROHS | Compliant | Compliant | Compliant |

It can be seen from Table 1 that the high-voltage and high-current laminated bus line prepared by the present invention has good physical properties, and the steady-state current exceeds 30 kV, so that the bus line can be directly suitable for high-power electrical equipment.

The above descriptions are only preferred embodiments of the present invention. It should be noted that those of ordinary skill in the art can also make several improvements and modifications without departing from the principle of the present invention, and such improvements and modifications shall fall within the protection scope of the present invention.

What is claimed is:

1. A high-voltage and high-current laminated bus line, comprising an insulated positive bus line, a metal isolation plate, and an insulated negative bus line; wherein
the metal isolation plate is positioned between the insulated positive bus line and the insulated negative bus line, the insulated positive bus line comprises a first insulating layer and a positive bus line, the insulated negative bus line comprises a second insulating layer and a negative bus line, and a thickness of the first insulating layer and the second insulating layer is 1-10 mm independently;
the first insulating layer and the second insulating layer are a glass cloth tape; and wherein
a preparation method of the high-voltage and high-current laminated bus line comprises the following steps:
winding the positive bus line and the negative bus line by using the glass cloth tape to form the insulated positive bus line and the insulated negative bus line, twining the insulated positive bus line, the metal isolation plate, and the insulated negative bus line by using the glass cloth tape to form a laminated bus line sample, and heating and curing the laminated bus line sample to obtain the high-voltage and high-current laminated bus line; wherein
a thickness of the twining is 1-10 mm; and
the heating and curing is performed at 160-180° C. for 20-30 h.

2. The high-voltage and high-current laminated bus line according to claim 1, wherein cross-sectional areas of the positive bus line and the negative bus line are 10000-15000 mm² independently.

3. The high-voltage and high-current laminated bus line according to claim 2, wherein centers of the positive bus line and the negative bus line each comprise a water through hole, and an area of the water through hole is 300-400 mm² independently.

4. The high-voltage and high-current laminated bus line according to claim 2, wherein the positive bus line, the negative bus line, and the metal isolation plate are independently made of any one of aluminum, copper, aluminum alloy, and copper alloy.

5. A preparation method of the high-voltage and high-current laminated bus line according to claim 1, comprising the following steps:
winding the positive bus line and the negative bus line by using the glass cloth tape to form the insulated positive bus line and the insulated negative bus line, twining the insulated positive bus line, the metal isolation plate, and the insulated negative bus line by using the glass cloth tape to form the laminated bus line sample, and heating and curing the laminated bus line sample to obtain the high-voltage and high-current laminated bus line; wherein
the thickness of the twining is 1-10 mm; and
the heating and curing is performed at 160-180° C. for 20-30 h.

6. The preparation method according to claim 5, wherein the positive bus line and the negative bus line are coated with an epoxy adhesive and are wound with the glass cloth tape; and the glass cloth tape is saturated with the epoxy adhesive.

7. The preparation method according to claim 6, wherein the epoxy adhesive comprises an epoxy resin and/or a curing agent anhydride.

8. The preparation method according to claim 6, wherein after the heating and curing is completed, the laminated bus line sample is subjected to a temperature reduction treatment and a surface passivation treatment in sequence.

9. The preparation method according to claim 8, wherein the temperature reduction treatment is performed at a rate of ≤2° C./min.

10. The high-voltage and high-current laminated bus line according to claim 3, wherein the positive bus line, the negative bus line, and the metal isolation plate are independently made of any one of aluminum, copper, aluminum alloy, and copper alloy.

11. The preparation method according to claim 5, wherein in the high-voltage and high-current laminated bus line, cross-sectional areas of the positive bus line and the negative bus line are 10000-15000 mm² independently.

12. The preparation method according to claim 11, wherein in the high-voltage and high-current laminated bus line, centers of the positive bus line and the negative bus line each comprise a water through hole, and an area of the water through hole is 300-400 mm² independently.

13. The preparation method according to claim 11, wherein in the high-voltage and high-current laminated bus line, the positive bus line, the negative bus line, and the metal isolation plate are independently made of any one of aluminum, copper, aluminum alloy, and copper alloy.

14. The preparation method according to claim 7, wherein after the heating and curing is completed, the laminated bus line sample is subjected to a temperature reduction treatment and a surface passivation treatment in sequence.

15. The preparation method according to claim 12, wherein in the high-voltage and high-current laminated bus line, the positive bus line, the negative bus line, and the metal isolation plate are independently made of any one of aluminum, copper, aluminum alloy, and copper alloy.

16. The preparation method according to claim 11, wherein the positive bus line and the negative bus line are coated with an epoxy adhesive and are wound with the glass cloth tape; and the glass cloth tape is saturated with the epoxy adhesive.

17. The preparation method according to claim 12, wherein the positive bus line and the negative bus line are coated with an epoxy adhesive and are wound with the glass cloth tape; and the glass cloth tape is saturated with the epoxy adhesive.

18. The preparation method according to claim 13, wherein the positive bus line and the negative bus line are coated with an epoxy adhesive and are wound with the glass cloth tape; and the glass cloth tape is saturated with the epoxy adhesive.

19. The preparation method according to claim 15, wherein the positive bus line and the negative bus line are coated with an epoxy adhesive and are wound with the glass cloth tape; and the glass cloth tape is saturated with the epoxy adhesive.

20. The preparation method according to claim 16, wherein the epoxy adhesive comprises an epoxy resin and/or a curing agent anhydride.
